(19) United States
(12) Patent Application Publication
(10) Pub. No.: US 2017/0280913 A1
(43) Pub. Date: Oct. 5, 2017

(54) KNOCKDOWN POUR-OVER KETTLE AND KETTLE COVER THEREOF

(71) Applicant: acaia Corporation, Cupertino, CA (US)

(72) Inventor: Rex Poway TSENG, Cupertino, CA (US)

(73) Assignee: acaia Corporation, Cupertino, CA (US)

(21) Appl. No.: 15/085,969

(22) Filed: Mar. 30, 2016

(51) Int. Cl. A47J 27/21; A47J 31/00

(52) U.S. Cl. CPC A47J 27/21175; A47J 31/005; A47J 27/21191

(57) ABSTRACT

A knockdown pour-over kettle includes a kettle body and a first and a second kettle cover that are detachably assembled together. The first kettle cover can be installed in a first end of the kettle body to close the first end or removed from the first end to open the same. The second kettle cover can be detachably installed in a second end of the kettle body and has a base portion and a spout portion. Differently sized spout portions can be selectively detachably coupled to an end of a communicating passage formed in the base portion to communicate with a liquid storing space in the kettle body for pouring water. A third kettle cover can take the place of the second kettle cover to close the second end, so that the assembled kettle body and first and third kettle covers together form a thermo flask structure.

### FIELD OF THE INVENTION

The present invention relates to a pour-over kettle for pouring hot water into a beverage container, and more particularly, to a knockdown pour-over kettle that is conveniently portable and may have differently sized spout portions selectively coupled thereto according to a user's actual need in use, and may also have a differently designed kettle cover detachably connected to an end thereof to transform the pour-over kettle into a thermo flask structure.

### BACKGROUND OF THE INVENTION

Generally, when someone wants to brew coffee, he/she will first grind an amount of roasted coffee beans to powder form and then use a brewing device to brew the ground coffee beans to make a cup of coffee. Different brewing devices and different brewing methods can produce different coffee tastes and flavors.

According to different coffee brewing methods, there are generally three types of coffee drinks, namely, instant coffee that is brewed by directly adding hot water to the prepared coffee powder, simmered coffee that is prepared by simmering ground coffee beans in a pot, and drip coffee that is brewed with hot water and paper filter. Generally, when make drip coffee, a pour-over kettle having a long narrow spout is used to control the flow and speed of hot water adding to the ground coffee beans.

Further, the temperature of hot water for brewing coffee also has an important influence on the flavor of drip coffee. Therefore, when make drip coffee, a thermometer will also be used to test the water temperature in the course of brewing coffee, so as to make a good cup of coffee with rich aroma.

FIG. 1 shows a conventional pour-over kettle 1, which has integrally formed metal kettle body 10, spout 11 and handle 12. The kettle body 10 has a top opening openably closed with a lid 13. The lid 13 is provided with an air vent 14 to allow the water stored in the kettle body 10 to smoothly flow out via the spout 11.

The conventional integrally formed pour-over kettle has a large volume and is therefore not conveniently portable. In the event a different water flow and speed is required to brew a desired coffee, another pour-over kettle capable of providing such water flow and speed will be needed. That is, a user has to prepare multiple pour-over kettles of different spout sizes for making coffee drinks of different flavors. Besides, vapor and heat in the kettle body will leak via the air vent provided on the lid, bringing the hot water in the kettle body to cool quickly. Therefore, hot water of required temperature must be replenished from time to time.

Further, in most cases, the kettle body of the conventional pour-over kettle has an outer wall made of a copper material or a stainless steel material. Therefore, heat from the hot water will be directly transferred to the whole metal kettle body, and a user's hands touching the heated kettle body are easily burnt.

### SUMMARY OF THE INVENTION

A primary object of the present invention is to provide a knockdown pour-over kettle, which is conveniently portable and allows a user not only to use another differently designed kettle cover to transform the kettle into a thermo flask structure, but also to use differently sized spout portions suitable for brewing different types of coffee drinks or other beverages.

Another object of the present invention is to provide a knockdown pour-over kettle, a cover of which is provided with air vents, which can be selectively closed or opened, and a through hole, via which a thermometer can be directly inserted into the kettle for testing the temperature of water in the kettle, making the knockdown pour-over kettle more convenient for brewing coffee or other beverages.

A further object of the present invention is to provide a knockdown pour-over kettle that has a kettle body formed of an inner and an outer wall, so that a vacuum inter-wall space is defined between the two walls, giving the kettle a thermal insulating effect and a burn-protection effect.

To achieve the above and other objects, the knockdown pour-over kettle according to the present invention includes a kettle body, a first kettle cover and a second kettle cover. The kettle body is a hollow cylindrical body formed of an inner wall and an outer wall. The cylindrical body has a first end defining a first opening and a second end defining a second opening; and the first opening, the second opening and the inner wall together define a liquid storing space therebetween.

The first kettle cover is installed in the first opening of the cylindrical body to close the first end of the kettle body, and the first kettle cover is selectively detachably from the first opening to open the first end of the kettle body.

The second kettle cover is installed in the second opening of the cylindrical body and includes a base portion configured to close the second end of the kettle body and a spout portion coupled to the base portion. The base portion has a communicating passage formed therein to communicate the spout portion with the liquid storing space. The kettle body, the first kettle cover and the second kettle cover are assembled together to serve as a pour-over kettle.

In addition, the knockdown pour-over kettle further includes a third kettle cover. When the second kettle cover is removed from the second opening of the cylindrical body, the third kettle cover can be installed in the second opening of the cylindrical body in place of the second kettle cover to give the kettle body a sealed bottom, whereby the kettle body, the first kettle cover and the third kettle cover are assembled together to form a structure functioning like a thermo flask.

The first kettle cover includes a lower cover portion and an upper cover portion. The lower cover portion is provided with at least one air vent for communicating the liquid storing space with a space outside the kettle body. The upper cover portion is movably assembled to the lower cover portion to cover the lower cover portion and close the at least one air vent. And, the upper cover portion is selectively movable relative to the lower cover portion to open the at least one air vent. Further, the inner wall and the outer wall of the cylindrical body of the kettle body together define between them an inter-wall space, which is in a vacuum state.

In an operable embodiment of the present invention, the upper cover portion is provided with a through hole that extends from a top to a bottom of the upper cover portion. The through hole is able to align and communicate with one air vent on the lower cover portion through turning of the upper cover portion relative to the lower cover portion. The base portion of the second kettle cover has a bottom cover section, which is configured to be located outside the second opening to cover the second opening, and a raised section, which is located atop the bottom cover section to upwardly protrude into the second opening and is provided on around an outer surface with a locking section for fixing to the inner wall of the kettle body. The spout portion of the second kettle cover has an inlet end located closer to the base portion and an outlet end located farther from the base portion, and the inlet end has an inner diameter no smaller than that of the outlet end.

In another operable embodiment of the present invention, the upper cover portion includes a threaded stem and the lower cover portion includes a threaded hole for correspondingly meshing with the thread stem. When the upper cover portion is turned and the threaded stem is brought to move in a rotational motion, the threaded stem is also guided by the threaded hole of the lower cover portion to move up or down in a linear motion relative to the lower cover portion, bringing the upper cover portion to locate farther from or closer to the lower cover portion. According to this embodiment, the spout portion also has an inlet end having an inner diameter no smaller than that of an outlet end.

In a third operable embodiment of the present invention, the upper cover portion includes an engaging element and the lower cover portion is provided with an engaging hole for correspondingly receiving the engaging element therein. The engaging element is deformable to move into and engage with the engaging hole when the engaging element is subjected to a linear push and generates a compressive force against the engaging hole. On the other hand, the engaging element is deformable to disengage from the engaging hole when the engaging element is pulled relative to the engaging hole.

An O-ring is installed at an interface between the first kettle cover and the inner wall of the kettle body, and another O-ring between the second kettle cover and the inner wall of the kettle body, so as to avoid leakage of liquid from the liquid storing space via any joint tolerance for assembling the first and the second kettle cover to the kettle body.

The knockdown pour-over kettle of the present invention further includes a detachable handle, allowing a user to conveniently install the handle at the user's discretion. The handle includes a coupling portion for removably fitting around an outer side of the kettle body and a grip portion connected to the coupling portion.

A still further object of the present invention is to provide a kettle cover for a knockdown pour-over kettle. The kettle cover is detachably installed on an open end of a kettle body of the knockdown pour-over kettle, allowing a user to conveniently remove it from the kettle body and install another desired type of kettle cover according to actual need in making coffee or other beverages.

To achieve the above object, the kettle cover for a knockdown pour-over kettle according to the present invention is configured for detachably installing in an opening of a kettle body of the knockdown pour-over kettle. The kettle cover includes a base portion and a spout portion. The base portion has a bottom cover section, which is configured to be located outside the opening of the kettle body to cover the opening, and a raised section, which is located atop the bottom cover section to upwardly protrude into the opening and is provided on around an outer surface with a locking section for fixing to an inner wall of the kettle body. Further, the base portion has a communicating passage formed therein to extend in a fluid-communicating manner from a top of the raised section to one side of the bottom cover section. The spout portion is coupled to an end of the communicating passage formed in the base portion and has an inlet end located closer to the base portion and an outlet end located farther from the base portion.

In an operable embodiment of the kettle cover, an O-ring is fitted on around a lower part of the raised section of the base portion, and the inlet end of the spout portion has an inner diameter larger than that of the outlet end. However, in another operable embodiment of the kettle cover, the inlet end of the spout portion is otherwise designed to have an inner diameter equal to that of the outlet end.

The present invention is characterized in that the kettle body, the first kettle cover, the second kettle cover and the third kettle cover of the knockdown pour-over kettle are detachably assembled to one another, so that the pour-over kettle is conveniently portable and allows a user to selectively install a second kettle cover that has a spout portion sized most suitable for making a cup of a desired beverage, or to replace the second kettle cover with the third kettle cover to transform the pour-over kettle into a thermo flask structure.

Further, the first kettle cover for the knockdown pour-over kettle of the present invention is formed of an upper cover portion and a lower cover portion that are movable relative to each other, and the upper and the lower cover portion are provided with a through hole and at least one air vent, respectively. The through hole can be aligned with one of the air vents by turning the upper cover portion relative to the lower cover portion. With these arrangements, a user can insert a thermometer into the kettle for testing the temperature of the hot water stored in the pour-over kettle without the need of removing the first kettle cover from the kettle body.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a conventional pour-over kettle;

FIG. 2 is a perspective view of a knockdown pour-over kettle according to a first embodiment of the present invention;

FIG. 3 is a sectional view of FIG. 2;

FIG. 4 is an exploded view of FIG. 2, showing a kettle body, a first kettle cover and a second kettle cover of the knockdown pour-over kettle according to the first embodiment of the present invention;

FIG. 5 shows the manner of opening an air vent provided on the first kettle cover shown in FIG. 4;

FIG. 6 is an exploded perspective view of the second kettle cover shown in FIG. 4;

FIG. 7 shows the use of the knockdown pour-over kettle of FIG. 2 to pour hot water;

FIG. 8 is an exploded perspective view showing the knockdown pour-over kettle of the present invention is usable with a third kettle cover in place of the second kettle cover;

FIG. 9 shows a manner of inserting a thermometer into the knockdown pour-over kettle of the present invention;

FIG. 10 shows another manner of inserting a thermometer into the knockdown pour-over kettle of the present invention;

FIG. 11 is a perspective view of another embodiment of the first kettle cover according to the present invention;

FIG. 12 shows the manner of opening the air vents on the first kettle cover of FIG. 11;

FIG. 13 is a perspective view of another embodiment of the second kettle cover according to the present invention; and

FIG. 14 is a sectional view of a knockdown pour-over kettle according to a second embodiment of the present invention.

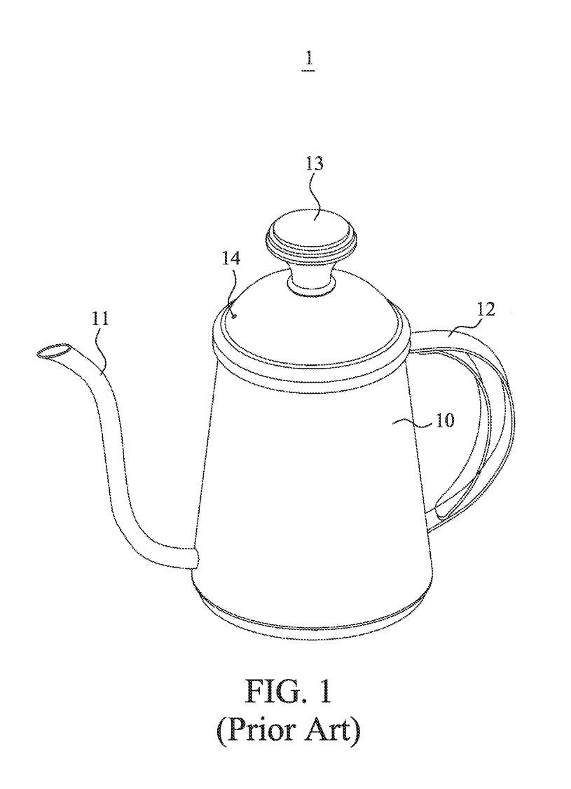

### DETAILED DESCRIPTION OF THE PREFERRED EMBODIMENTS

The present invention will now be described with some preferred embodiments thereof and by referring to the accompanying drawings. For the purpose of easy to understand, elements that are the same in the preferred embodiments are denoted by the same reference numerals.

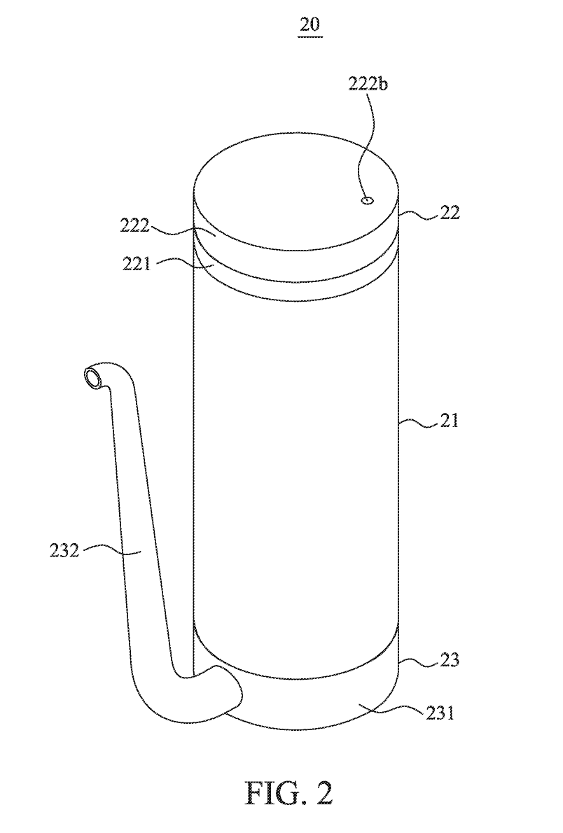

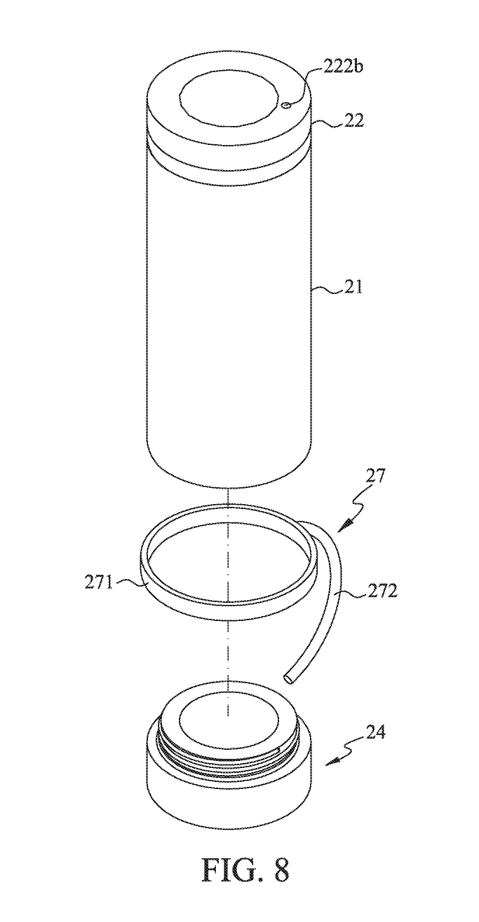

Please refer to FIGS. 2 and 8. A knockdown pour-over kettle 20 according to a first embodiment of the present invention includes a kettle body 21, a first kettle cover 22, a second kettle cover 23, and a third kettle cover 24 that may be used to replace the second kettle cover 23. The kettle body 21, the first kettle cover 22 and the second kettle cover 23 can be assembled together to serve as a pour-over kettle, while the kettle body 21, the first kettle cover 22 and the third kettle cover 24 can be assembled together to serve as a thermo flask structure.

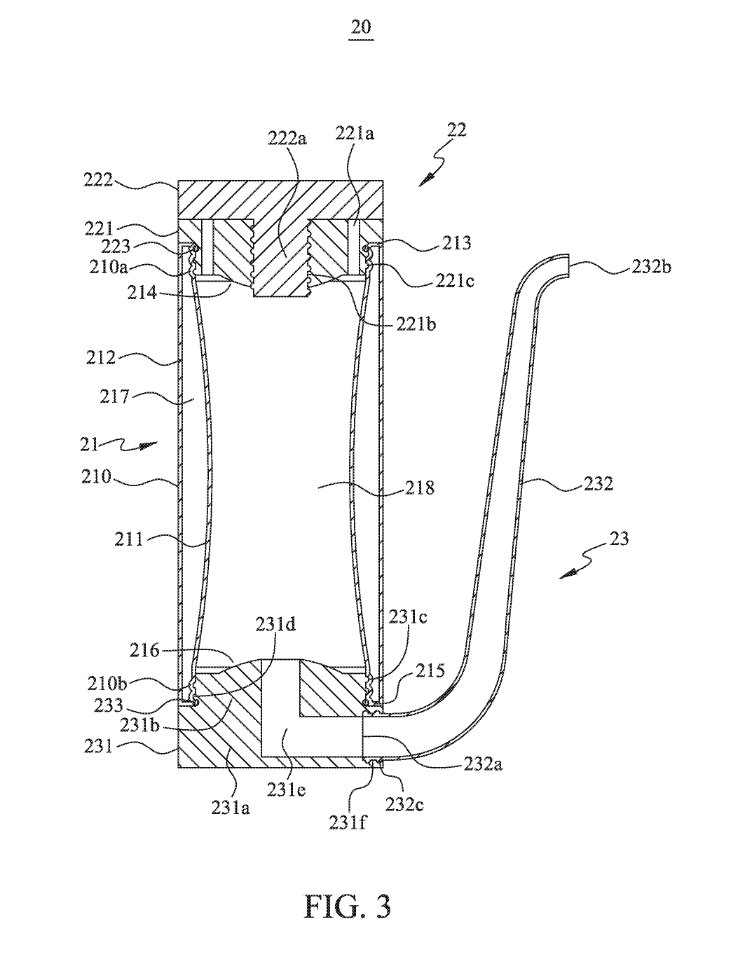

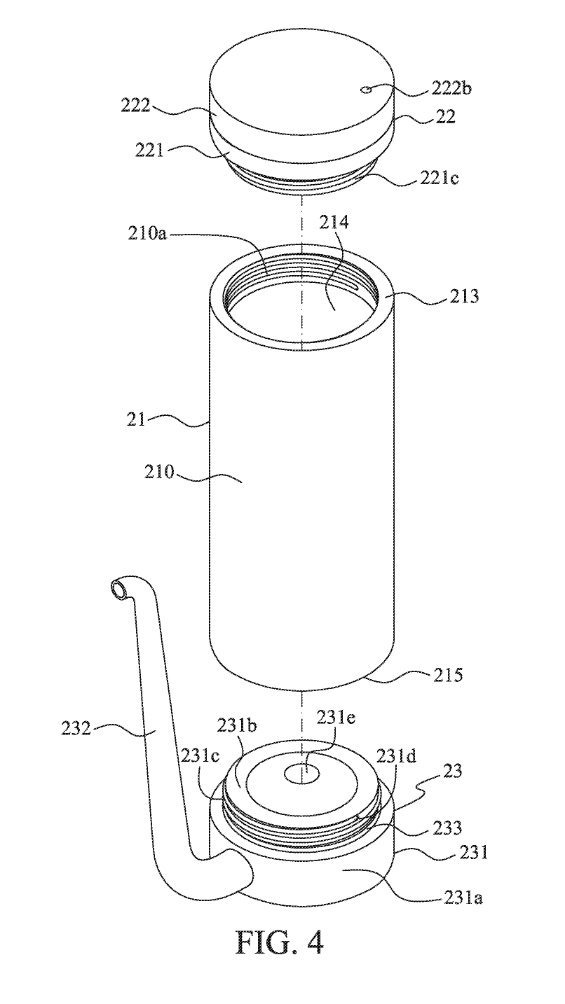

Please refer to FIGS. 3 and 4, which are sectional and exploded perspective views, respectively, of the first embodiment of the present invention. As shown, the kettle body 21 is configured as a hollow cylindrical body 210 formed of an inner wall 211 and an outer wall 212. The cylindrical body 210 has a first end 213 defining a first opening 214 and a second end 215 defining a second opening 216. An inter-wall space 217 in a vacuum state is defined between the inner wall 211 and the outer wall 212 to give the kettle body 21 a burn-protection effect, so that user's hands holding the kettle body 21 that has hot water stored therein are protected against burning by heat. And, the first opening 214, the second opening 216 and the inner wall 211 together define a liquid storing space 218 between them.

Further, the cylindrical body 210 is provided on the inner wall 211 at the first end 213 with a first internal thread 210a, and at the second end 215 with a second internal thread 210b. The inner wall 211 gradually reduces in diametrical size from the first end 213 and the second end 215 toward a middle portion of the inner wall 211 and accordingly shows a radially inward curved configuration. However, it is understood the above described inner wall design is only illustrative and not intended to limit the present invention in any way. That is, the inner wall 211 may be otherwise a straight wall linearly extended from the first end 213 to the second end 215, such that the liquid storing space 218 defined therein is a cylindrical space (not shown).

The first kettle cover 22 is installed in the first opening 214 of the cylindrical body 210 to close the first end 213 of the kettle body 21. Further, the first kettle cover 22 can be selectively detached from the first opening 214 to open the first end 213 of the kettle body 21.

The first kettle cover 22 includes a lower cover portion 221 and an upper cover portion 222. The lower cover portion 221 is provided with at least one air vent 221a for communicating the liquid storing space 218 with a space outside the kettle body 21. In the illustrated first embodiment, two air vents 221a can be seen in the drawings. The upper cover portion 222 is movably assembled to the lower cover portion 221 to cover the latter and close the air vents 221a. The upper cover portion 222 can be selectively moved relative to the lower cover portion 221, such that a parting space is produced between the upper cover portion 222 and the lower cover portion 221 to enable communication of the air vents 221a with the space outside the kettle body 21.

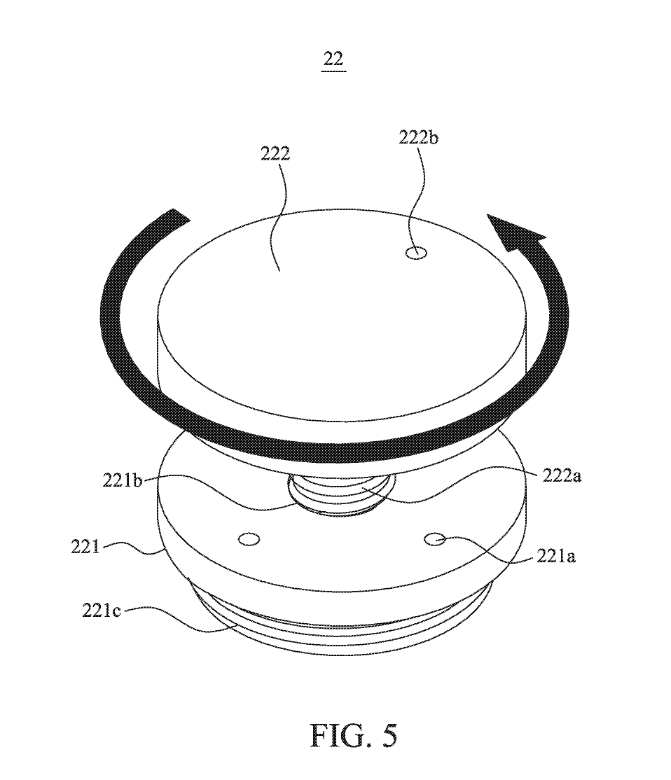

Please refer to FIG. 5. In the illustrated first embodiment of the present invention, the upper cover portion 222 includes a threaded stem 222a, and the lower cover portion 221 includes a threaded hole 221b corresponding to the threaded stem 222a. Further, the lower cover portion 221 is provided around a lower part with a first external thread 221c for meshing with the first internal thread 210a. When the upper cover portion 222 is turned by a user, the threaded stem 222a of the upper cover portion 222 is brought to move in a rotational motion. At this point, the rotating threaded stem 222a is also guided by the threaded hole 221b of the lower cover portion 221 to move up or down in a linear motion, so that the upper cover portion 222 can be located farther from or closer to the lower cover portion 221. In addition, the upper cover portion 222 is provided with a through hole 222b that extends from a top to a bottom of the upper cover portion 222. By turning the upper cover portion 222 relative to the lower cover portion 221, the through hole 222b can be brought to align and communicate with one of the air vents 221a.

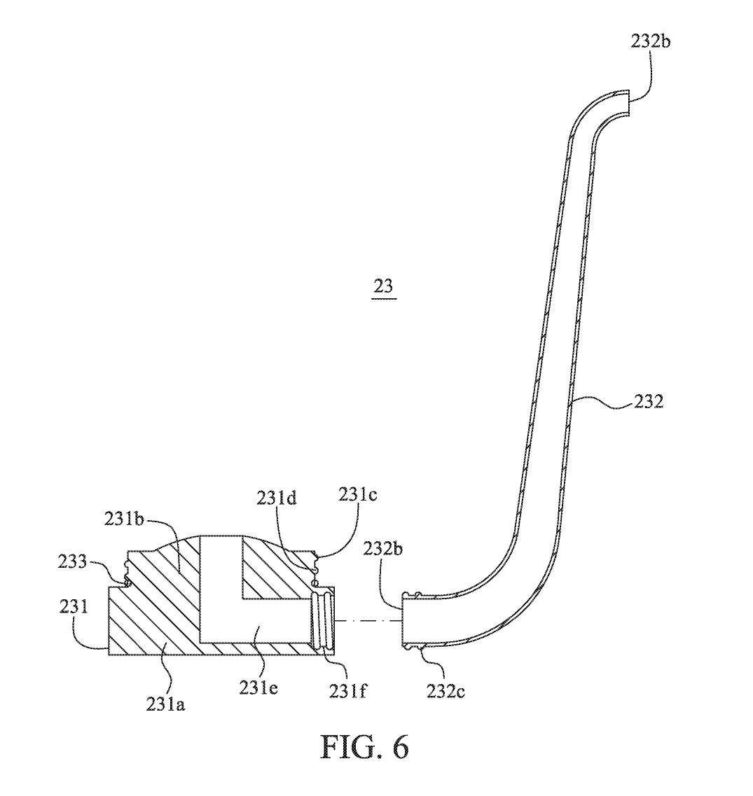

Please refer to FIGS. 3, 4 and 6. The second kettle cover 23 is installed in the second opening 216 of the cylindrical body 210, and it includes a base portion 231 configured to close the second end 215 of the kettle body 21 and a spout portion 232 coupled to the base portion 231. The base portion 231 has a bottom cover section 231a, which is located outside the second opening 216 to cover the latter; a raised section 231b, which is located atop the bottom cover section 231a to upwardly protrude into the second opening 216; a locking section 231c, which is located on around the raised section 231b for fixing to the inner wall 211 of the kettle body 21, and can be in the form of a second external thread 231d for meshing with the second internal thread 210b; and a communicating passage 231e, which is formed in between the raised section 231b and the bottom cover section 231a to communicate the spout portion 232 with the liquid storing space 218 and is provided near an end adjacent to the spout portion 232 with an internal thread 231f.

The spout portion 232 has an inlet end 232a located closer to the base portion 231 and an outlet end 232b located farther from the base portion 231. The inlet end 232a is provided with an external thread 232c for meshing with the internal thread 231f in the communicating passage 231e. Further, the inlet end 232a has an inner diameter larger than that of the outlet end 232b.

An O-ring 223 can be installed at an interface between the first kettle cover 22 and the inner wall 211 of the kettle body 21, and another O-ring 233 between the second kettle cover 23 and the inner wall 211 of the kettle body 21, so as to avoid leakage of liquid from the liquid storing space 218 via any joint tolerance for assembling the first and the second kettle cover 22, 23 to the kettle body 21. In the illustrated first embodiment, the O-ring 223 for the first kettle cover 22 is fitted on around the lower cover portion 221, and the O-ring 233 for the second kettle cover 23 is fitted on around the raised section 231b between the locking section 231c and the bottom cover section 231a.

To use the knockdown pour-over kettle 20, first turn the first kettle cover 22 at the lower cover portion 221 thereof, so as to remove the first kettle cover 22 from the knockdown pour-over kettle 20 and open the first end 213. Then, pour hot water 25 into the liquid storing space 218 of the kettle body 21 via the first opening 214 and then put back and turn the lower cover portion 221 of the first kettle cover 22 again to close the first end 213 of the knockdown pour-over kettle 20.

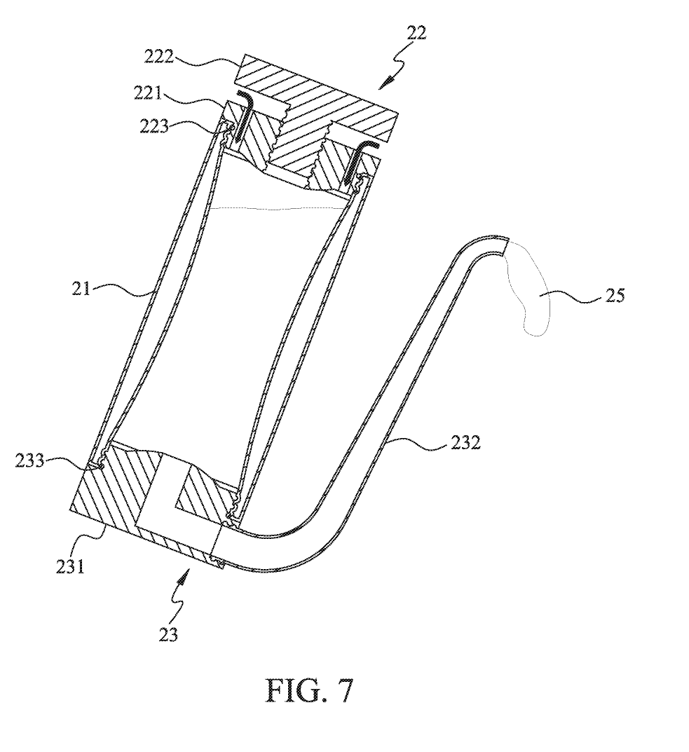

Referring to FIG. 7. To make a cup of coffee with the knockdown pour-over kettle 20, directly turn the upper cover portion 222 of the first kettle cover 22 to partially lift the upper cover portion 222 and accordingly open the air vents 221a on the lower cover portion 221. At this point, external air can flow through the air vents 221a into the liquid storing space 218 to compress the hot water 25 therein, so that the hot water 25 can flow out through the communicating passage 231e in the second kettle cover 23 and the spout portion 232 when the knockdown pour-over kettle 20 is in a tilted position.

Referring to FIG. 8. When the knockdown pour-over kettle 20 is not used to make coffee, a user may remove the second kettle cover 23 from the second opening 216 of the cylindrical body 210 and install the third kettle cover 24 in the second opening 216 to seal a bottom of the kettle body 21. In this manner, the assembled kettle body 21, first kettle cover 22 and third kettle cover 23 can together serve as a thermo flask structure, which is conveniently portable by a user to hold drinking water therein.

Further, a handle 27 can be detachably assembled to an outer side of the kettle body 21 of the knockdown pour-over kettle 20. The handle 27 includes a coupling portion 271 and a grip portion 272. As shown in FIG. 8, the coupling portion 271 is configured as a loop structure for fitting around the outer side of the kettle body 21. The kettle body 21 can have a conical shaped outer wall surface that slightly tapered from top to bottom, so that the coupling portion 271 of the handle 27 can be fitted on around the kettle body 21 from a bottom thereof. The grip portion 272 is a reverse C-shaped member extended from one side of the coupling portion 271. A user may select to or not to install the handle 27 on the pour-over kettle or the thermo flash completely at his/her discretion.

However, it is understood the above description of the kettle body 21 is only illustrative. For example, in another operable embodiment, the kettle body 21 may be otherwise provided with a coupling member, to which the coupling portion 271 of the handle 27 can be assembled. Many other simple changes and modifications in the configuration of the kettle body 21 can be still carried out and should be considered a part of the concept of the detachable handle 27.

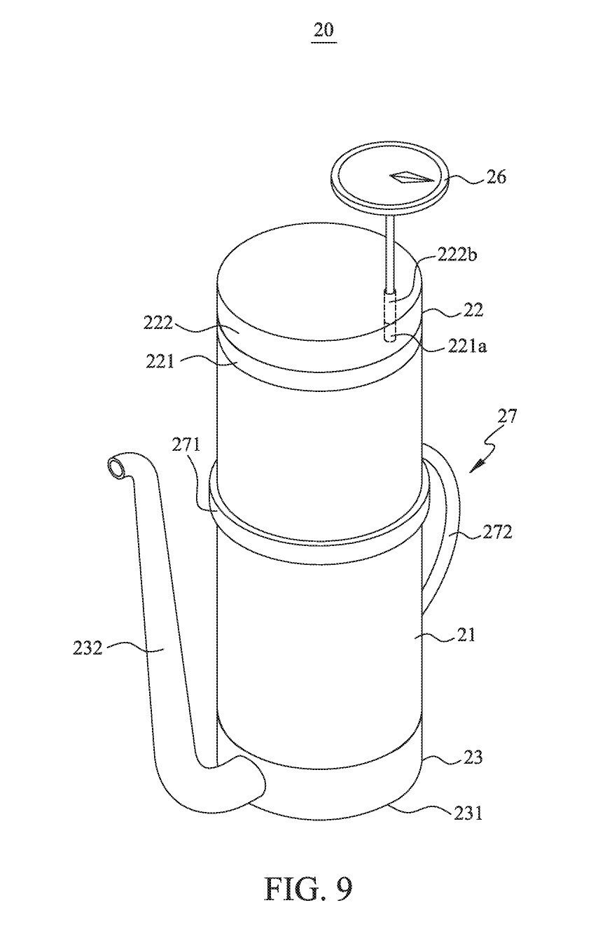

Please refer to FIG. 9. When a user wants to know the temperature of the hot water 25 in the liquid storing space 218, he/she simply turns the upper cover portion 222 relative to the lower cover portion 221 to align the through hole 222b with one of the air vents 221a and inserts a thermometer 26 through the aligned through hole 222b and air vent 221a into the hot water 25 in the liquid storing space 218. From the reading of the thermometer 26, the user can find out whether the hot water 25 is at a temperature most suitable for making coffee.

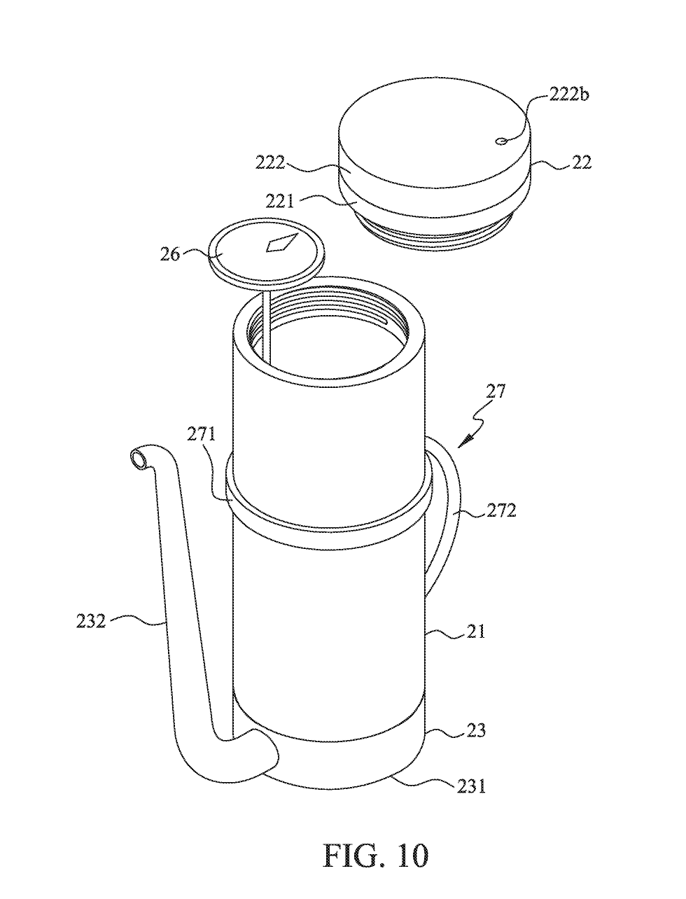

Referring to FIG. 10. In the event the water temperature is too low, simply remove the first kettle cover 22 from the kettle body 21 and add an amount of hot water 25 to the liquid storing space 218, and insert the thermometer 26 into the hot water 25 to check the temperature again. Repeat the above steps until the hot water 25 reaches the optimum temperature for the desired coffee beans. On the other hand, in the event the water temperature is too high, simply remove the first kettle cover 22 from the kettle body 21, let the kettle 20 stand still, and insert the thermometer 26 into the hot water 25 until the reading of the thermometer 26 lowers to the optimum temperature for making coffee with the desired coffee beans.

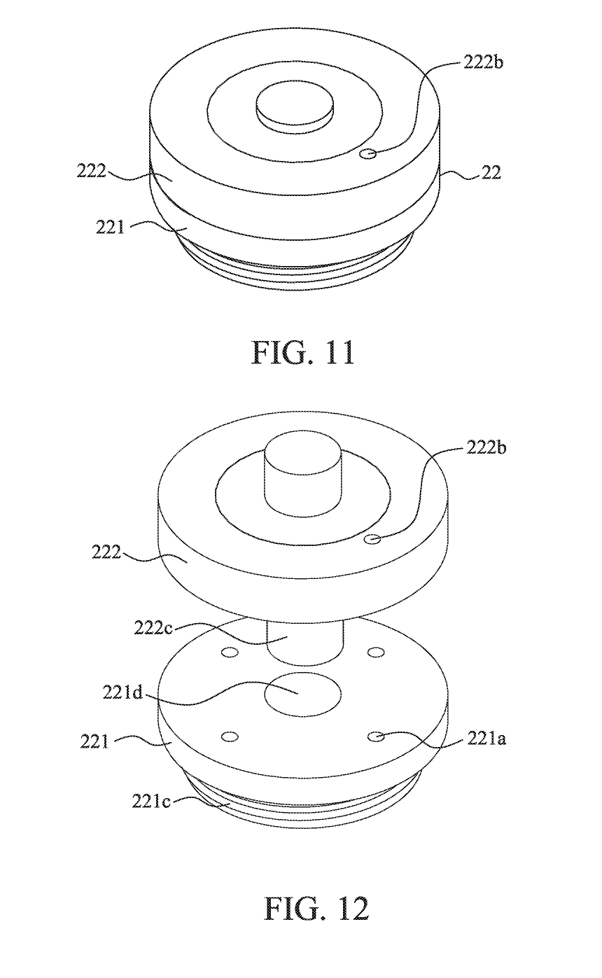

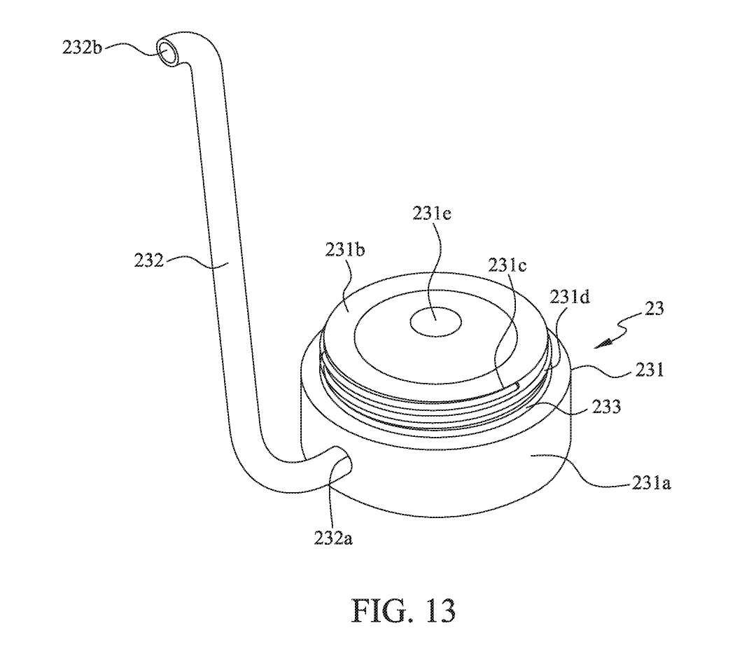

In FIGS. 11 and 12, there is shown another embodiment of the first kettle cover 22. In this embodiment, the upper cover portion 222 of the first kettle cover 22 includes an elastically deformable engaging element 222c, and the lower cover portion 221 is provided with an engaging hole 221d for correspondingly receiving the engaging element 222c therein. When the upper cover portion 222 is subjected to a downward linear push, the engaging element 222c thereof generates a compressive force against the engaging hole 221d and deforms to move into and engage with the engaging hole 221d. On the other hand, when the upper cover portion 222 is subjected to an upward linear pull, the engaging element 222c is also deformed and extracted from the engaging hole 221d to expose the air vents 221a. FIG. 13 shows another embodiment of the second kettle cover 23. In this embodiment, the inlet end 232a of the spout portion 232 of the second kettle cover 23 has an inner diameter the same as that of the outlet end 232b.

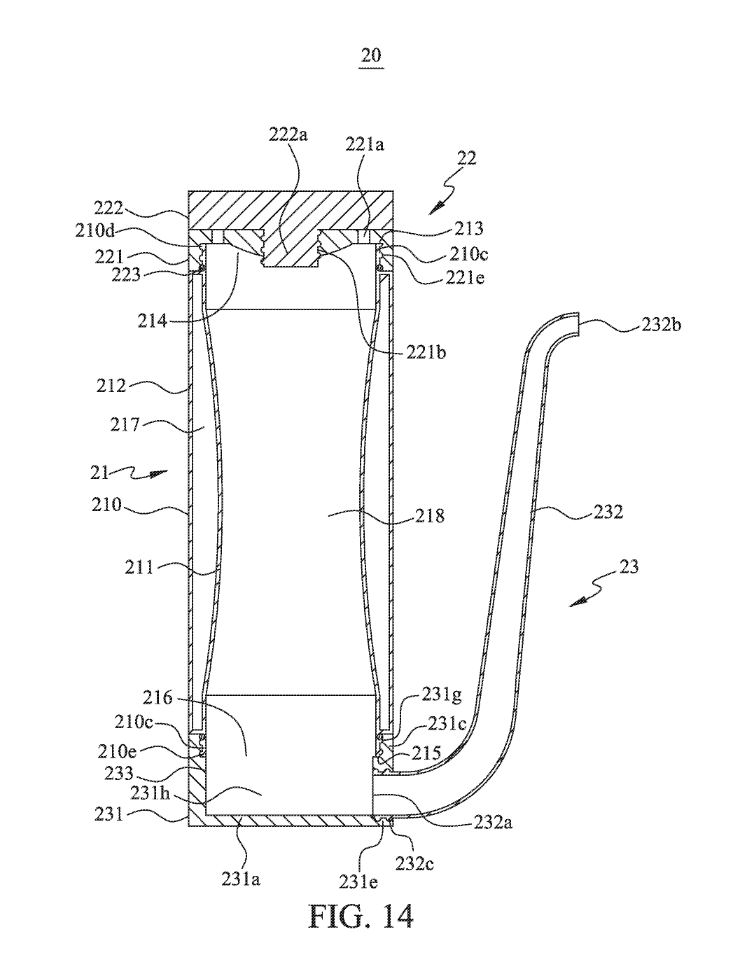

Finally, please refer to FIG. 14, which is a sectional view showing the knockdown pour-over kettle 20 according to a second embodiment of the present invention. The knockdown pour-over kettle 20 in the second embodiment is different from the first embodiment mainly in that the cylindrical body 210 of the kettle body 21 has a neck portion 210c axially outward extended from each of the first end 213 and the second end 215. The neck portion 210c adjoining the upper end 213 is provided on an outer side with an upper external thread 210d and the neck portion 210c adjoining the lower end 215 is provided on an outer side with a lower external thread 210e. In this case, the lower cover portion 221 of the first kettle cover 22 is provided at a position in contact with the upper external thread 210d with a lower internal thread 221e for correspondingly meshing with the upper external thread 210d. Further, in the second embodiment of the present invention, the bottom cover section 231a of the base portion 231 of the second kettle cover 23 is inward sunken to form a recess 231h, and a position of the recess 231h in contact with the lower external thread 210e is provided with an upper internal thread 231g for correspondingly meshing with the lower external thread 210e. In this case, the spout portion 232 is coupled to the recess 231h.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A knockdown pour-over kettle, comprising:
a kettle body being a hollow cylindrical body formed of an inner wall and an outer wall, the cylindrical body having a first end defining a first opening and a second end defining a second opening, and the first opening, the second opening and the inner wall together defining a liquid storing space therebetween;
a first kettle cover being installed in the first opening of the cylindrical body to close the first end of the kettle body, and the first kettle cover being selectively detachably from the first opening to open the first end of the kettle body; and
a second kettle cover being installed in the second opening of the cylindrical body and including a base portion configured to close the second end of the kettle body and a spout portion coupled to the base portion; and the base portion having a communicating passage formed therein to communicate the spout portion with the liquid storing space; and
wherein the kettle body, the first kettle cover and the second kettle cover are assembled together to serve as a pour-over kettle.

2. The knockdown pour-over kettle as claimed in claim 1, further comprising a third kettle cover; the second kettle cover being selectively removable from the second opening of the cylindrical body and the third kettle cover being selectively installed in the opened second opening of the cylindrical body in place of the second kettle cover to give the kettle body a sealed bottom, whereby the kettle body, the first kettle cover and the third kettle cover are assembled together to form a structure functioning like a thermo flask.

3. The knockdown pour-over kettle as claimed in claim 1, wherein the first kettle cover includes a lower cover portion and an upper cover portion; the lower cover portion being provided with at least one air vent for communicating the liquid storing space with a space outside the kettle body, the upper cover portion being movably assembled to the lower cover portion to cover the lower cover portion and close the at least one air vent, and the upper cover portion being selectively movable relative to the lower cover portion to open the at least one air vent.

4. The knockdown pour-over kettle as claimed in claim 3, wherein the upper cover portion is provided with a through hole that extends from a top to a bottom of the upper cover portion; and the through hole being able to align and communicate with one air vent on the lower cover portion through turning of the upper cover portion relative to the lower cover portion.

5. The knockdown pour-over kettle as claimed in claim 3, wherein the upper cover portion includes a threaded stem and the lower cover portion includes a threaded hole for correspondingly meshing with the thread stem; whereby when the upper cover portion is turned and the threaded stem is brought to move in a rotational motion, the threaded stem is also guided by the threaded hole of the lower cover portion to move up or down in a linear motion relative to the lower cover portion, bringing the upper cover portion to locate farther from or closer to the lower cover portion.

6. The knockdown pour-over kettle as claimed in claim 3, wherein the upper cover portion includes an engaging element and the lower cover portion is provided with an engaging hole for correspondingly receiving the engaging element therein; the engaging element being deformable to move into and engage with the engaging hole when the engaging element is subjected to a linear push and generates a compressive force against the engaging hole; and the engaging element being deformable to be extracted from the engaging hole when the engaging element is pulled relative to the engaging hole.

7. The knockdown pour-over kettle as claimed in claim 1, further comprising a detachable handle; the handle including a coupling portion for removably fitting on around an outer side of the kettle body and a grip portion connected to the coupling portion.

8. The knockdown pour-over kettle as claimed in claim 1, wherein the base portion of the second kettle cover has a bottom cover section, which is configured to be located outside the second opening to cover the second opening, and a raised section, which is located atop the bottom cover section to upwardly protrude into the second opening and is provided on around an outer surface with a locking section for fixing to the inner wall of the kettle body; and wherein the spout portion of the second kettle cover has an inlet end located closer to the base portion and an outlet end located farther from the base portion, and the inlet end having an inner diameter no smaller than that of the outlet end.

9. The knockdown pour-over kettle as claimed in claim 1, wherein the base portion of the second kettle cover has a bottom cover section, which is configured to be located outside the second opening to cover the second opening; the bottom cover section being inward sunken to form a recess, and the recess being provided on around an inner surface with a locking section for fixing to the outer wall of the kettle body; and wherein the spout portion of the second kettle cover has an inlet end located closer to the base portion and an outlet end located farther from the base portion, and the inlet end having an inner diameter no smaller than that of the outlet end.

10. The knockdown pour-over kettle as claimed in claim 1, wherein the inner wall and the outer wall of the cylindrical body of the kettle body together define between them an inter-wall space, which is in a vacuum state to give the kettle body a burn-protection effect, so that user's hands holding the kettle body that has hot water stored therein are protected against burning by heat.

11. A kettle cover for a knockdown pour-over kettle, the knockdown pour-over kettle including a kettle body having an opening and the kettle cover being removably installed in the opening of the kettle body, the kettle cover comprising:
a base portion having a bottom cover section, which is configured to be located outside the opening of the kettle body to cover the opening, and a raised section, which is located atop the bottom cover section to upwardly protrude into the opening and is provided on around an outer surface with a locking section for fixing to an inner wall of the kettle body; and the base portion having a communicating passage formed therein to extend in a fluid-communicating manner from a top of the raised section to an outer side of the bottom cover section; and
a spout portion being coupled to an end of the communicating passage formed in the base portion and having an inlet end located closer to the base portion and an outlet end located farther from the base portion; and the inlet end having an inner diameter no smaller than that of the outlet end.

12. A kettle cover for a knockdown pour-over kettle, the knockdown pour-over kettle including a kettle body having an opening and the kettle cover being removably installed in the opening of the kettle body, the kettle cover comprising:
a base portion having a bottom cover section, which is configured to be located outside the opening of the kettle body to cover the opening; the bottom cover section being inward sunken away from the opening of the kettle body, and the recess being provided on around an inner surface with a locking section for fixing to an outer wall of the kettle body; and the base portion having a communicating passage formed therein to extend in a fluid-communicating manner from an inner side of the recess to an outer side of the bottom cover section; and
a spout portion being coupled to an end of the communicating passage formed in the base portion and having an inlet end located closer to the base portion and an outlet end located farther from the base portion; and the inlet end having an inner diameter no smaller than that of the outlet end.
